(19) United States
(12) Patent Application Publication
(10) Pub. No.: US 2019/0255434 A1
(43) Pub. Date: Aug. 22, 2019

(54) METHODS AND SYSTEMS FOR A SERVICE-ORIENTED ARCHITECTURE FOR PROVIDING SHARED MIXED REALITY EXPERIENCES

(71) Applicant: James Wilson, Raleigh, NC (US)

(72) Inventor: James Wilson, Raleigh, NC (US)

(21) Appl. No.: 16/280,456

(22) Filed: Feb. 20, 2019

Related U.S. Application Data
(60) Provisional application No. 62/633,292, filed on Feb. 21, 2018.

(51) Int. Cl. A63F 13/35; H04L 29/06; A63F 13/213; A63F 13/65; A63F 13/215

(52) U.S. Cl. CPC A63F 13/35; H04L 67/38; A63F 13/213; A63F 13/65; A63F 2300/1087; A63F 2300/8082; A63F 2300/1025; A63F 2300/55; A63F 2300/69; A63F 13/215

(57) ABSTRACT

Disclosed herein are methods, systems, and devices for providing shared mixed reality experiences via a service-oriented architecture (SOA). According to one embodiment, a method is implemented on at least one server and includes identifying interface requirements for a set of services to be implemented between SOA front-end components and SOA back-end components. At least one of the SOA front-end components is configured for communicating with at least one augmented reality (AR) user interface and at least one of the SOA back-end components is configured for communicating with at least one virtual object library. The SOA front-end components are operable to be combined with the SOA back-end components to form an operable SOA solution.

### PRIORITY CLAIM

This application claims priority to U.S. Provisional Patent Application Ser. No. 62/633,292 filed Feb. 21, 2018, the disclosure of which is incorporated herein by reference in its entirety.

### TECHNICAL FIELD

The present invention relates to middleware solutions including front-end and back-end components. More specifically methods and systems are disclosed for providing shared mixed reality experiences via a service-oriented architecture (SOA).

### BACKGROUND

Virtual reality (VR) provides users an immersion into an artificial environment created within one or more computing systems. Augmented reality (AR) provides users overlays of virtual reality (and/or virtual objects) onto their real-world environment. Basically, the user's real-world is enhanced with virtual reality. Mixed reality provides more than just the overlays, but also anchors virtual reality to the users' real world. Users are allowed to interact simultaneously with both the real world and the virtual world. Many new devices are coming to the market that provide users with affordable and access to realistic AR and VR experiences. As such new methods and systems are needed for both development and integration allowing shared mixed reality experiences for these users

### SUMMARY

Disclosed herein are methods and systems for solving the problem of providing shared mixed reality experiences for a plurality of users. According to one embodiment, a method is disclosed for providing shared mixed reality experiences for a plurality of users. The method is implemented on at least one server and includes identifying interface requirements for a set of services to be implemented between service-oriented architecture (SOA) front-end components and SOA back-end components. At least one of the SOA front-end components is configured for communicating with at least one augmented reality (AR) user interface and at least one of the SOA back-end components is configured for communicating with at least one virtual object library. The SOA front-end components are operable to be combined with the SOA back-end components to form an operable SOA

### Solution

In some embodiments, at least one of the SOA front-end components may be configured for communicating with at least one virtual reality (VR) user interface and at least at least one of the SOA back-end components may be configured for communicating with at least one VR environment. At least one of the SOA front-end components may be configured for communicating with at least one real world interface. The at least one real world interface may be provided by a photo camera, a video camera, and/or a microphone. At least one of the SOA front-end components may also be configured for providing an administrator access secure web portal. The administrator access secure web portal may be configured to provide status and control of the operable SOA solution.

In some embodiments, the at least one AR user interface may be provided by an AR headset. The AR headset may be at least one of a Vuzix Blade AR headset, a Meta Vision Meta 2 AR headset, a Optinvent Ora-2 AR headset, a Garmin Varia Vision AR headset, a Solos AR headset, an Everysight Raptor AR headset, a Magic Leap One headset, an ODG R-7 Smartglasses System, an iOS ARKit compatible device, an ARCore compatible device, or the like. The at least one VR user interface may be provided by a VR headset. The VR headset may be at least one of a Pansonite 3D VR headset, a VRIT V2 VR headset, an ETVR, a Topmaxions 3D VR glasses, a Pasonomi VR headset, a Sidardoe 3D VR Headset, a VR Elegiant VR headset, a VR Box VR headset, a Bnext VR headset, a Vive VR headset, and Oculus Rift VR headset, or the like. The at least one virtual object library may be the Google Poly VR and AR virtual library. The at least one VR environment may be a massively multiplayer online game (MMOG), a collaborative VR environment, or a massively multiplayer online real-life game (MMORLG).

In other embodiments, the AR user interface may be provided by at least one of a personal computer (PC), a workstation, a laptop, a smart TV, a smartphone, a holographic projector, or the like. Likewise, the VR user interface may be provided by at least one of a personal computer (PC), a workstation, a laptop, a smart TV, a smartphone, a holographic projector, or the like.

In some embodiments, at least one of the SOA front-end components may be configured to communicate over the Internet and at least one of the SOA back-end components may be configured to communicate over the Internet. At least one of the SOA front-end components may be configured to communicate over at least one of an hypertext transfer protocol (HTTP) session, an HTTP secure (HTTPS) session, a secure sockets layer (SSL) protocol session, a transport layer security (TLS) protocol session, a datagram transport layer security (DTLS) protocol session, a file transfer protocol (FTP) session, a user datagram protocol (UDP), a transmission control protocol (TCP), and a remote direct memory access (RDMA) transfer. At least one of the SOA back-end components may be configured to communicate over at least one of an HTTP session, an HTTPS session, an SSL protocol session, a TLS protocol session, a DTLS protocol session, an FTP session, a UDP, a TCP, and an RDMA transfer.

In some embodiments, the at least one server may be a portion of a networked computing environment. The networked computing environment may be a cloud computing environment and the at least one server may be a virtualized server.

In some embodiments, the operable SOA solution may be configured to generate at least one real world virtual object using information received from the real world interface. The operable SOA solution may be further configured to provide the at least one real world virtual object to the at least one AR user interface, the at least one VR user interface, the at least one virtual object library (e.g. off-line storage), and/or the at least one VR environment.

In another embodiment, a server is disclosed for providing shared mixed reality experiences for a plurality of users. The server includes at least one processor and a memory. The at least one processor is configured for identifying interface requirements for a set of services to be implemented between SOA front-end components and SOA back-end components. At least one of the SOA front-end components is configured for communicating with at least one AR user interface and at least one of the SOA back-end components is configured for communicating with at least one virtual object library. The SOA front-end components are operable to be combined with the SOA back-end components to form an operable SOA solution.

In another embodiment, a non-transitory computer readable storage medium is disclosed for providing shared mixed reality experiences. The non-transitory computer-readable storage medium includes instructions to be implemented on at least one computing device including at least one processor, the instructions when executed by the at least one processor cause the at least one computing device to identify interface requirements for a set of services to be implemented between SOA front-end components and SOA back-end components. At least one of the SOA front-end components is configured for communicating with at least one AR user interface and at least one of the SOA back-end components is configured for communicating with at least one virtual object library. The SOA front-end components are operable to be combined with the SOA back-end components to form an operable SOA solution.

The features and advantages described in this summary and the following detailed description are not all-inclusive. Many additional features and advantages will be apparent to one of ordinary skill in the art in view of the drawings, specification, and claims presented herein.

### BRIEF DESCRIPTION OF THE DRAWINGS

The present embodiments are illustrated by way of example and are not intended to be limited by the figures of the accompanying drawings. In the drawings:

FIG. 1 depicts a block diagram illustrating a service-oriented architecture (SOA) for providing shared mixed reality experiences in accordance with embodiments of the present disclosure.

FIG. 2 depicts a block diagram illustrating a basic hardware server implementation for hosting the SOA in accordance with embodiments of the present disclosure.

FIG. 3 depicts a block diagram illustrating basic implementations for the SOA of Scene Flow in accordance with embodiments of the present disclosure.

FIG. 4 depicts a diagram illustrating a simple scene in accordance with embodiments of the present disclosure.

FIG. 5 depicts a diagram illustrating a scene with three zones and one director, two managers, and multiple actors in accordance with embodiments of the present disclosure.

FIG. 6 depicts a diagram illustrating how zones may scale to different dimensions and still show the same scene in accordance with embodiments of the present disclosure.

FIG. 7 depicts a diagram illustrating how two users view and participate in a scene together in accordance with embodiments of the present disclosure.

FIG. 8 depicts a diagram illustrating a real table from a first zone being projected into a second zone in accordance with embodiments of the present disclosure.

FIG. 9 depicts a flowchart illustrating a flow for users joining a scene in accordance with embodiments of the present disclosure.

FIG. 10 depicts a flowchart illustrating another flow for users joining a scene in accordance with embodiments of the present disclosure.

FIG. 11 illustrates a simple setup for delivering audio to certain zones in accordance with embodiments of the present disclosure.

FIG. 12 depicts a diagram illustrating a simple setup for delivering audio to all zones in accordance with embodiments of the present disclosure.

FIG. 13 depicts a diagram illustrating a developer isolating the audio from each zone for a battlefield game in accordance with embodiments of the present disclosure.

FIG. 14 depicts a diagram illustrating a simple scene where a person is using a tablet to view the scene in accordance with embodiments of the present disclosure.

FIG. 15 depicts a diagram illustrating Scene Flow managing multiple scenes and zones within those scenes for a customer in accordance with embodiments of the present disclosure.

FIG. 16 depicts a diagram illustrating depicts two zones setup for a scene in accordance with embodiments of the present disclosure.

FIG. 17 depicts a diagram illustrating the platformer action game concept in accordance with embodiments of the present disclosure.

FIG. 18 depicts a block diagram illustrating a virtual reality/augmented reality (VR/AR) headset in accordance with embodiments of the present disclosure.

FIG. 19 depicts a block diagram illustrating a mobile device in accordance with embodiments of the present disclosure.

### DETAILED DESCRIPTION

The following description and figures are illustrative and are not to be construed as limiting. Numerous specific details are described to provide a thorough understanding of the disclosure. However, in certain instances, well-known or conventional details are not described in order to avoid obscuring the description. References to “one embodiment” or “an embodiment” in the present disclosure can be, but not necessarily are, references to the same embodiment and such references mean at least one of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification, including examples of any terms discussed herein, is illustrative only, and is not intended to further limit the scope and meaning of the disclosure or of any exemplified term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions, will control.

The subject matter disclosed herein relates to middleware (e.g. a service-oriented architecture) including front-end and back-end components. More specifically; devices, systems, and methods are disclosed for enabling a middleware solution that solves the problem of efficiently developing and providing shared mixed reality experiences for users of AR and VR devices.

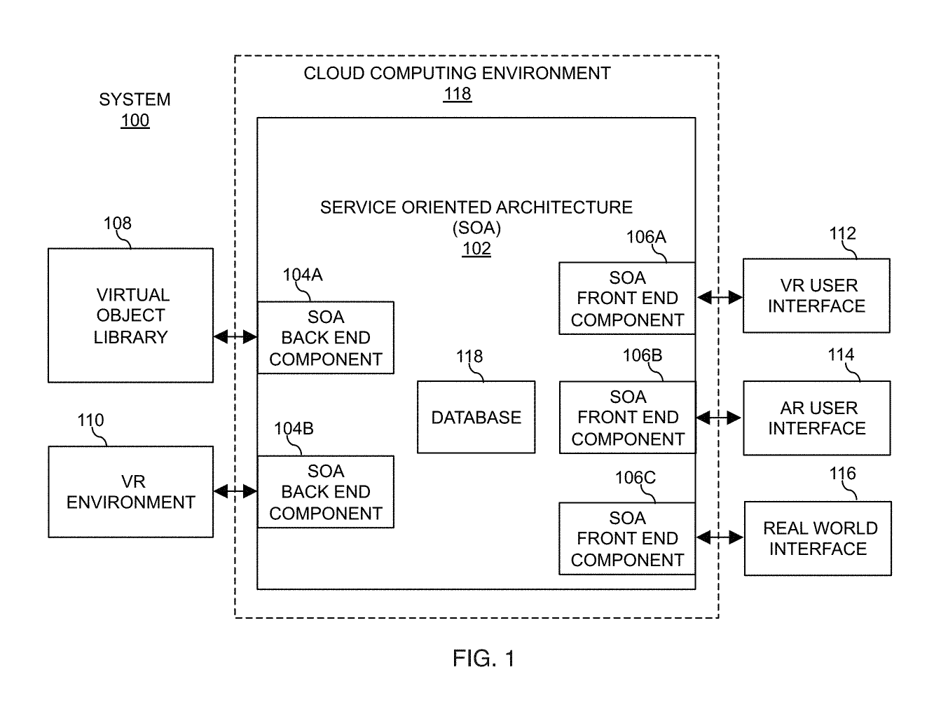

FIG. 1 depicts a system 100 illustrating a service-oriented architecture (SOA) 102 in accordance with embodiments of the present disclosure. The SOA 102 provides a collection of services, wherein the services communicate with each other. The communications may range from simple exchanges of data to two or more services coordinating one or more activities. Each service may be a function that is self-contained and well-defined. Each service may not depend on a state or context of each of the other services. The SOA 102 includes SOA back-end components 104A-B and front-end components 106A-C for developing and providing shared mixed reality experiences,

The SOA back-end component 104A is configured to communicate with at least one virtual object library 108 and the SOA back-end component 104B is configured to communicate with at least one VR environment 110. The SOA back-end components 104A-B may be coupled to the virtual object library 108 and the VR environment 110 by a combination of the Internet, wide area network (WAN) interfaces, local area network (LAN) interfaces, wired interfaces, wireless interfaces, and/or optical interfaces. In some embodiments the SOA back-end components 104A-B may also use one or more transfer protocols such as a hypertext transfer protocol (HTTP) session, an HTTP secure (HTTPS) session, a secure sockets layer (SSL) protocol session, a transport layer security (TLS) protocol session, a datagram transport layer security (DTLS) protocol session, a file transfer protocol (FTP) session, a user datagram protocol (UDP), a transport control protocol (TCP), or a remote direct memory access (RDMA) transfer protocol.

The SOA front-end component 106A is configured communicate with at least one virtual reality (VR) interface 112 and the SOA front-end component 106B is configured communicate with at least one augmented reality (AR) interface 114. The SOA front-end component 106C is configured communicate with at least one real world interface 116.

The SOA front-end components 104A-B may be coupled to the VR user interface 112, the AR user interface 114, and the real world interface 116 by a combination of the Internet, WAN interfaces, LAN interfaces, wired interfaces, wireless interfaces, and/or optical interfaces. The SOA front-end components 106A-C may also be configured to support multiple protocols and sessions such as an HTTP session, an HTTPS session, an SSL protocol session, a TLS protocol session, a DTLS protocol session, an FTP session, a UDP, a TCP, and an RDMA transfer protocol.

An additional front-end component (not shown in FIG. 1) may be configured to provide an administrator access secure web portal. The administrator access secure web portal may be configured to provide status and control of the operable SOA solution.

The SOA 102 may also include a database 118. In some embodiments, the database 118 may be an open source database such as the MongoDB® database, the PostgreSQL® database, or the like.

The AR user interface 114 may be provided by an AR headset such as a Vuzix Blade AR headset, a Meta Vision Meta 2 AR headset, a Optinvent Ora-2 AR headset, a Garmin Varia Vision AR headset, a Solos AR headset, an Everysight Raptor AR headset, a Magic Leap One headset, an ODG R-7 Smartglasses System, an iOS ARKit compatible device, an ARCore compatible device, or the like. The VR user interface 112 may be provided by a VR headset such as a Pansonite 3D VR headset, a VRIT V2 VR headset, an ETVR, a Topmaxions 3D VR glasses, a Pasonomi VR headset, a Sidardoe 3D VR Headset, a VR Elegiant VR headset, a VR Box VR headset, a Bnext VR headset, or the like. In some embodiments, the virtual object library 108 may be the Google Poly VR and AR virtual library, or the like. The VR environment may be a massively multiplayer online game (MMOG), a collaborative VR environment, a massively multiplayer online real-life game (MMORLG), or the like.

The SOA 102 may be implemented on one or more servers. The SOA 102 may include a non-transitory computer readable medium includes a plurality of machine-readable instructions which when executed by one or more processors of the one or more servers are adapted to cause the one or more servers to perform a method of providing shared mixed reality experiences for a plurality of users. In a preferred embodiment, the SOA 102 is implemented on a virtual (i.e. software implemented) server in a cloud computing environment 118. An Ubuntu® server 602 may provide the virtual server and may be implemented as a separated operating system (OS) running on one or more physical (i.e. hardware implemented) servers. Any applicable virtual server may by be used for the Ubuntu® Server function. The Ubuntu® Server function may be implemented in the Microsoft Azure®, the Amazon Web Services® (AWS), or the like cloud computing data center environments. In other embodiments, the SOA 102 may be implemented on one or more servers in a networked computing environment located within a business premise or another data center. In some embodiments, the SOA 102 may be implemented within a virtual container, for example the Docker® virtual container.

The SOA 102 transforms the virtual server, the virtual or the one or more servers into a machine that solves the problem of efficiently developing and providing shared mixed reality experiences for users of AR and VR devices. Specifically, the SOA front-end components are operable to be combined with the SOA back-end components to form an operable SOA solution.

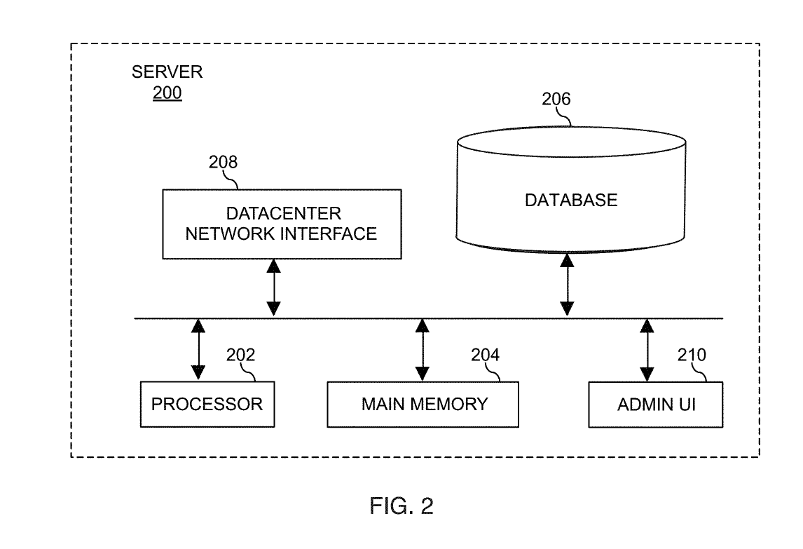

FIG. 2 depicts a block diagram illustrating a server 200 for hosting at least a portion of the SOA 102 in accordance with embodiments of the present disclosure. The server 200 is a hardware server and may include at least one of a processor 202, a main memory 204, a database 206, a datacenter network interface 208, and an administration user interface (UI) 210. The server 200 may be configured to host a virtual server. For example the virtual server may be an Ubuntu® server or the like. The server 200 may also be configured to host a virtual container. For example, the virtual server may be the Docker® virtual server or the like. In some embodiments, the virtual server and or virtual container may be distributed over a plurality of hardware servers using hypervisor technology.

The processor 202 may be a multi-core server class processor suitable for hardware virtualization. The processor 202 may support at least a 64-bit architecture and a single instruction multiple data (SIMD) instruction set. The main memory 204 may include a combination of volatile memory (e.g. random access memory) and non-volatile memory (e.g. flash memory). The database 206 may include one or more hard drives. The database 206 may provide at least a portion of the functionality of the database 118 of FIG. 1.

The datacenter network interface 208 may provide one or more high-speed communication ports to the data center switches, routers, and/or network storage appliances. The datacenter network interface may include high-speed optical Ethernet, InfiniBand (IB), Internet Small Computer System Interface iSCSI, and/or Fibre Channel interfaces. The administration UI may support local and/or remote configuration of the server by a data center administrator.

### Scene Flow

The Scene Flow system disclosed in the following paragraphs of this disclosure may be provided by the SOA 102 of FIG. 1. Scene Flow solves the problem of efficiently developing and providing shared mixed reality experiences for users of AR and VR devices. Specifically, Scene Flow's SOA front-end components are operable to be combined with Scene Flow's SOA back-end components to form an operable SOA solution.

Scene Flow improves upon the concept of group conferences. Today, users may have private audio and video chats with a select group of people around the world. This technology may also be used to present content by sharing the content from a person's device. For the first time people can include mixed-reality experiences as they designate real world spaces into a joint conference. These people can be in the same location, at separate locations, or both.

### Goals

Scene Flow makes it easier for developers to build apps and games that enable a shared mixed-reality experience between multiple people. Scene Flow can create and manage an n-dimensional scene that developers can build upon for mixed reality experiences. Scene Flow can allow a scene to be viewed from multiple zones so people can share the scene from different locations in the real world. Scene Flow can manage bringing people in-and-out of the zones for a particular scene.

### Uniqueness

Scenes and zones do not rely on screens (monitors, tvs, etc.) to bring people together. They rely on projecting virtual objects into physical spaces of the real world and sharing audio between those spaces. The sizes of the physical spaces do not matter. The service scales the scene to the size of the zone. People can interact with the same scene at different sizes. This service can find the best device for mapping data. Since Scene Flow knows which devices are connecting Scene Flow can pick-up the best mapping device to deliver the best AR experience to everyone in the room.

Scene Flow does not rely on video. The service has an emphasis on using app content and audio to bring people together. People can still view the scene as long as they have a device capable of producing an augmented reality image. If there input controls are not complex enough (e.g. a phone screen's two dimensional input) then they can still view the scene and participate through audio. Collaboration is built into the app by the developers and enabled by the Scene Flow service.

### Discussion of Related Art

Mixed-reality computing is still in its early days but there is a wide range of devices, products, and services that are growing around the field. Today, mixed reality apps can be broken down into three basic categories. First, there are simple apps that do not persist and allow for unique experiences by mixing simple digital ideas with the real world. The second type is a more personal experience that maps the world around a user and creates a digital world within the physical world. The third types are planet-scale experiences shared by everyone in the world. The most popular app in this category is Pokemon GO.

### SDKs and Game Engines

### Augmented Reality SDKs

Apple and Google are leaders in the first type of apps with ARKit and ARCore. They have Software Development Kits (SDKs) that allow developers to build augmented reality apps leveraging existing devices such as phones and tablets. These apps tend to be simpler in nature. For example, Ikea has created an app that lets a user place a digital version of a piece of furniture in the user's actual room. This allows them to see whether they like the furniture and whether it would fit in their desired location. Once the user is done using the app there is little need to save the data since it is easy to place the furniture in that same place again.

### Game Engines

The number of devices and platforms to build upon has been growing over the years and this has been a major challenge for people making video games. To solve this problem companies have built game engines that game developers can use to build games. These engines abstract away ideas such as the personal computer, mobile devices, and gaming consoles. This allows game developers to ship their games on more platforms then they might if they built everything internally. With the rise of Virtual Reality (VR) and Augmented Reality (AR) these game engines have picked up working in this space. Again, the key idea is to abstract away the need for working with ARKit and ARCore. They make sure that developers do not need to work with ARKit and ARCore directly.

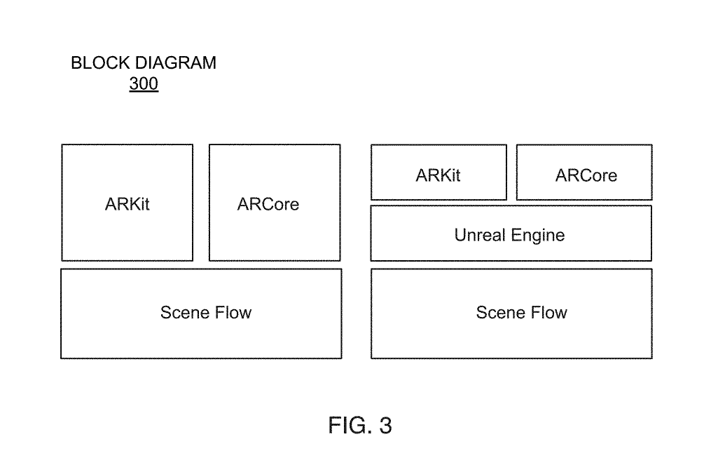

Scene Flow differs from a game engine because Scene Flow concentrates on making sure multiple people can enter and exit that particular scene. In fact, developers can use the Scene Flow service within these game engines to create mixed-reality apps and games. FIG. 3 depicts a block diagram 300 illustrating a basic implementation for the SOA of Scene Flow in accordance with embodiments of the present disclosure.

### Augmented Reality Headsets

There is much progress made by companies such as Microsoft and Magic Leap in producing personal mixed-reality spaces. The software can map large areas and allow the user to pin and leave mixed-reality content in specific places. While using their devices, the user can see the mixed-reality content still in the same location even after restarting the devices.

One of the key challenges these devices share is how apps are currently built on their platforms. They are not really meant to be shared with other people. This can change in the future, but will they work with iOS and Android or other platforms that will be built by Apple and Google later down the road? The answer is most likely no. The Scene Flow service makes sure that developers can have their mixed-reality experiences shared across multiple devices and platforms.

In addition, mixed-reality experiences can be better if they are shared instead of kept personal in a mixed-reality world, and Scene Flow can enable people to share those experiences. This platform allows for spaces to be easily shared within mixed-reality spaces and people's personal devices. People can continue to use devices such as phones, smart watches, and computers just because they find it more productive, they find them to be more secure, and the simple desire to not wear mixed-reality glasses all of the time.

### Planet-Based Apps

These apps leverage cloud technologies to allow people from all over the world to participate in a game. The most popular game to execute on this idea is Pokemon GO. The game uses Google Cloud to create monsters across the world at specific locations. Users are then able to hunt for these monsters by using an app on their phone. When Apple and Google released ARKit and ARCore, the developers at Niantic Labs improved the client apps leveraging the applicable SDKs provided by Apple and Google.

There are two key ways Scene Flow differentiates from the cloud-based apps. First, Scene Flow provides a service and infrastructure that makes it easier to build these types of apps.

Second, this is a global experience. People can join at a whim by simply downloading the appropriate app. Scene Flow improves this concept by giving developers the ability to create more nuanced experiences, by allowing users to control who can view and interact with a scene. For instance, maybe only family members should be allowed to participate in a scene, or people in a business meeting.

### Detailed Scene Flow Description

### Nomenclature

A scene is shared by people whether they are in the same room standing next to each other or looking at the scene from different zones.

A zone is an area a user has set up to view a particular scene. There can be multiple zones for a scene since all users might not be near each other at the time. Zones can be a physical space in the real world, or contained within an app on a device.

A director is the person that created the scene. They are also automatically a manager of the scene as well.

A manager is a person that establishes a zone that other people can join. Scene Flow uses the manager to help bring other people into the same zone so they have equal parity in the scene.

An actor is an active participant in the scene. These users are able to actually edit and manipulate a scene from a particular zone.

A spectator is a user that can only watch but not edit a particular scene. They can be registered as a spectator for two reasons. One, they lack the proper administrator rights to that scene. Two, they are viewing the scene from a device that is incapable of manipulating the scene.

An intermission is a pause in the scene. The scene is not deleted, but can always be brought back up by a new actor or spectator entering the scene. This is important for a time dimension on the scene as well since people do not need to see how long a scene has been inactive when viewing the scene from a time perspective.

### Space-Time Dimensions

Scene Flow creates a service that manages an n-dimensional space for any number of people. Below are a few dimensions that can be created using scenes.

2D is the space that is established on a wall or is in the middle of 3D space, but has no-depth. It is expected that people need to be standing in front of a 2D scene to view it.

3D is the space that is established with x, y, and z boundaries greater than zero. A scene can always be translated from 2D to 3D in special scenarios.

4D is a 3D space with an additional dimension of time. In this instance, the actors in the scene can manipulate time and have the ability to undo and redo the scene. Time can never go away.

It is worth noting that scenes do not need to be perfect squares or cubes. As the technology advances it might be worth having an augmented space that is two rooms connected by a stairway.

### Setting the Scene

### The Initial Scene

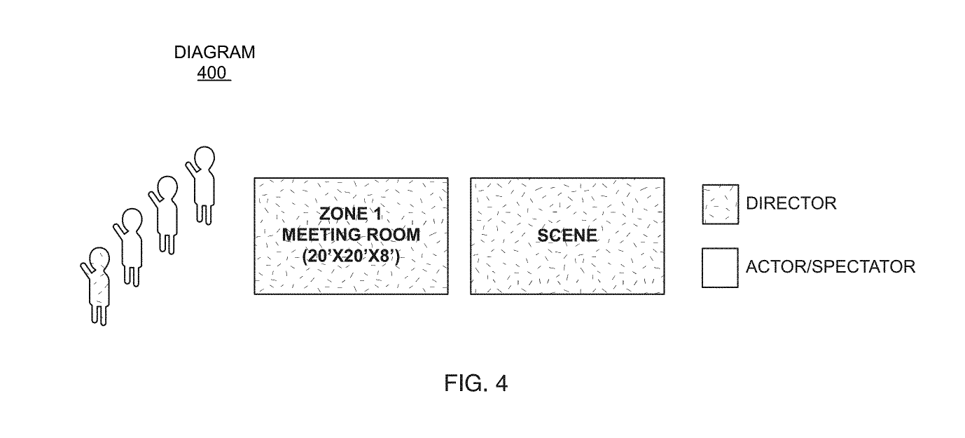

First Scene Flow establishes the scene. The first person to establish the scene is the director. When this occurs the scene is set up and the first zone is established which is the same size as the scene. This becomes the primary zone for people to participate in the scene. People in the same room can be invited in to see the mixed-reality scene. They can become participants in the scene. FIG. 4 depicts a diagram 400 illustrating a simple scene in accordance with embodiments of the present disclosure.

### Additional Zones

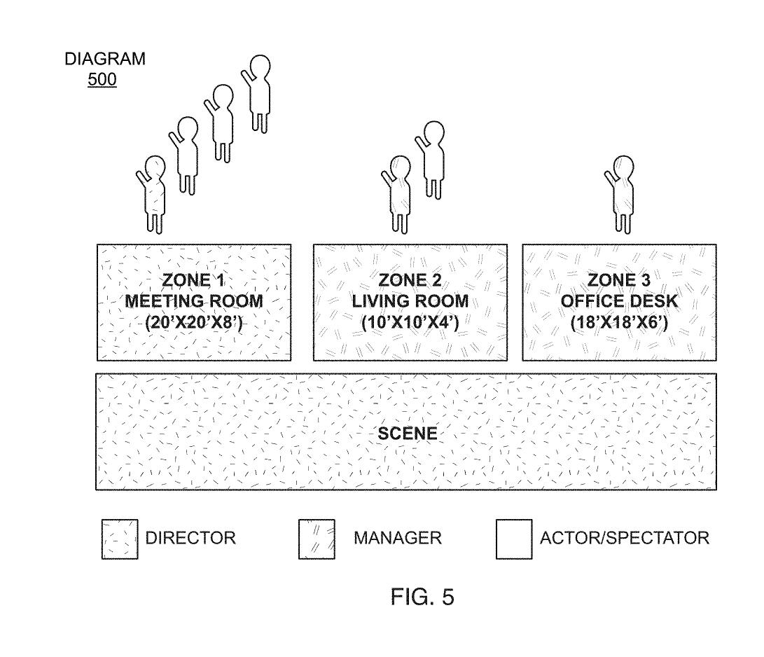

At this point there really is not much difference between the scene and a zone. However, if other people wish to join the scene and are not in the same physical space then Scene Flow sets up additional zones. There is not a limit to how many zones the user can have. The only requirement is having at least one person in the zone for it to remain active. FIG. 5 depicts a diagram 500 illustrating a scene with three zones and one director, two managers, and multiple actors in accordance with embodiments of the present disclosure. FIG. 5 illustrates that the zones do not need to be the same size. Zone 1 establishes the main size of the scene, and zones 2 and 3 are both smaller, but match the same dimensions

### Dimensions

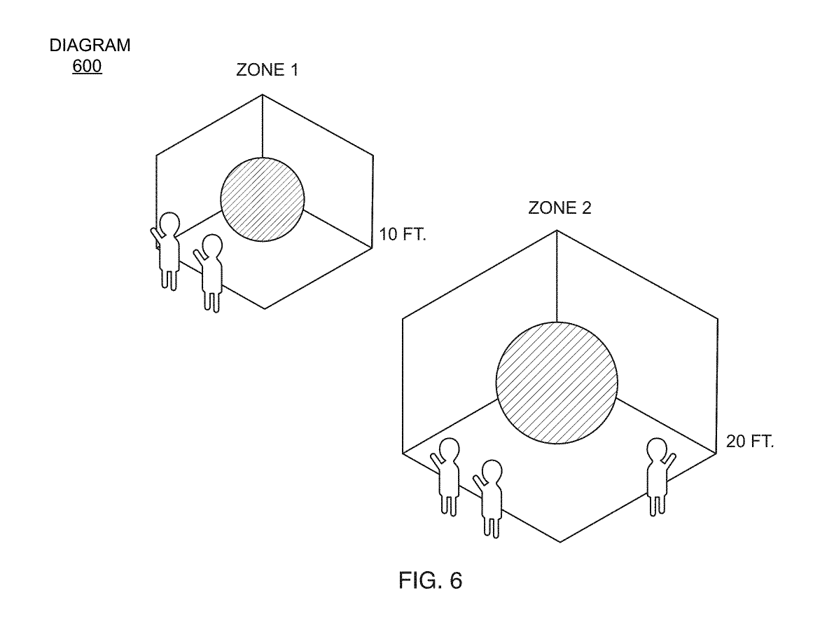

Managing the different sized zones is one of the biggest benefits of this service. Joe and Steve set up a scene that is 20′ by 20′. They invite Zoe to the scene, but she is working from home and needs to set up a new zone for the scene so she can participate. She only has a 10′ by 10′ open space to work with so the scene needs to be transformed for her zone. This service handles managing the different dimensions on the behalf of everyone. For the first time developers do not need to take into account different zone sizes when building their mixed reality apps and games. FIG. 6 depicts a diagram 600 illustrating how zones may scale to different dimensions yet still show the same scene in accordance with embodiments of the present disclosure.

This concept can be taken a step further and data produced from a device can generate a scene. Below in the classroom example, Scene Flow uses a Leap Motion controller as an example.

### Mapping

There is a major challenge to setting the scene and that is pinning down the exact location. This is crucial if people are sharing the same zone within a space. If there is any offset at all then people can find it challenging to share the same space as two people are pointing to the same thing, but they are seeing it from several inches apart since there is not a perfect parity between the two scenes. Different technologies can map the areas in different ways.

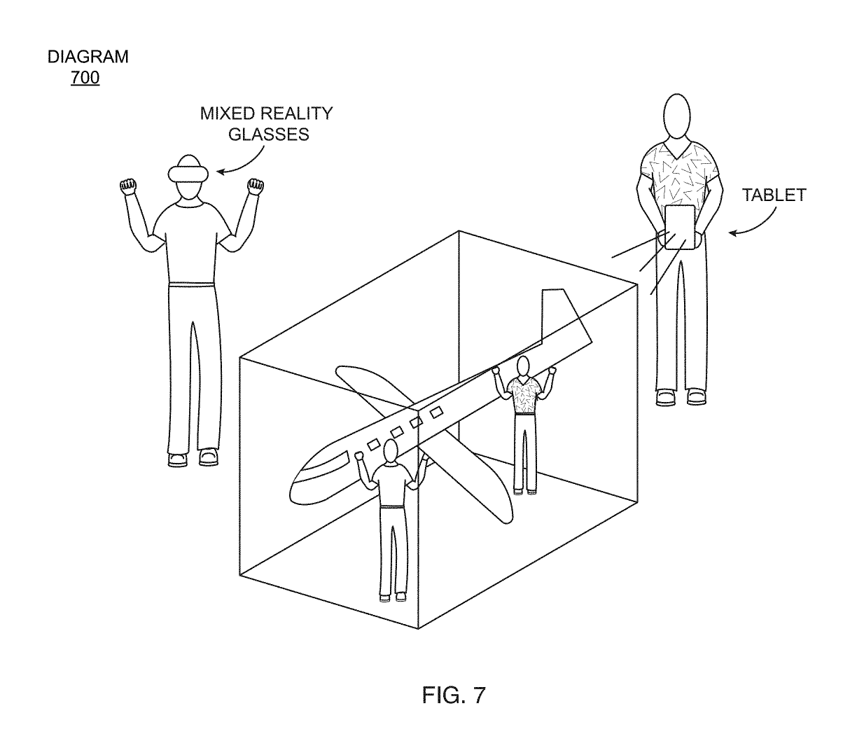

For instance, users have Apple's ARKit and Google's ARCore. In addition, users have device specific technologies such as HoloLens and Magic Leap. All of these attempt to accomplish the same goal in different ways, and that is mapping a physical space to properly place a mixed-reality scene. For the first time, developers can build collaborative apps that allow multiple mixed-reality devices to share and project the same scenes. FIG. 7 depicts a diagram 700 illustrating how two users view and participate in a scene together in accordance with embodiments of the present disclosure. One user is wearing mixed-reality glasses, and the other is using a computer tablet to view and interact with the scene.

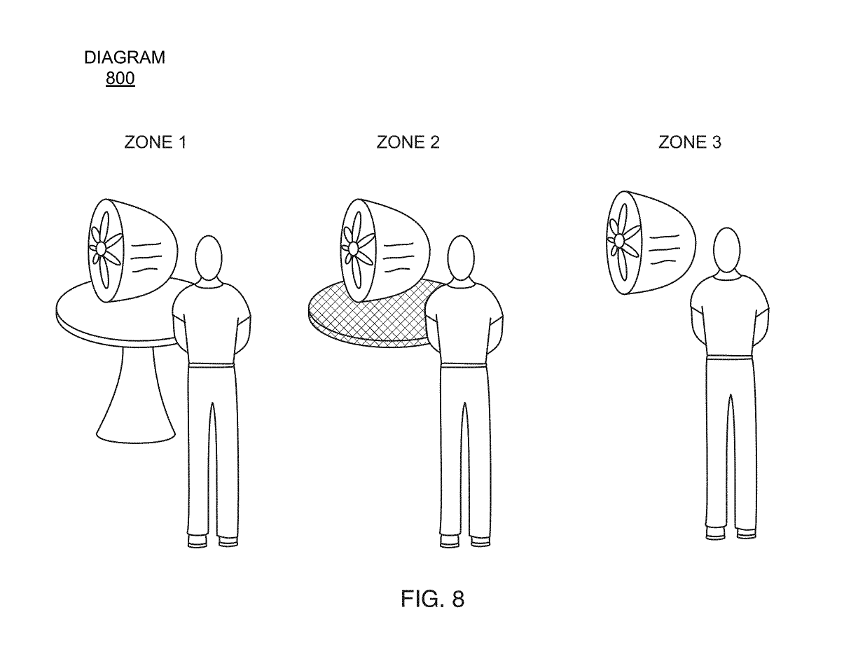

Scene Flow makes developers lives easier by abstracting the mapping away. They do not need to think about how the different SDKs are sending mapping data since Scene Flow handles that on their behalf. Since Scene Flow has directors and managers that are driving the scene and its location then it does not matter to the other actors and spectators how the mapping is being achieved. The service will look at the space they are mapping and fit the scene within that zone. FIG. 8 depicts a diagram 800 illustrating a real table from zone 1 being projected into zone 2 in accordance with embodiments of the present disclosure. The developers of the app have decided to show just a 3D mesh representation of any surface. The manager at zone 3 has disabled projecting the surface and is just viewing the hologram.

### Projecting Mapped Data

In addition, for the first time real world objects from one physical space can be projected into other real world locations. The FIG. 8 illustrates that a table top from zone 1 can be projected into other zones. This is an improvement on top of screen sharing today during teleconference meetings. Instead of just the content from a device being shared, Scene Flow can also replicate real-world object across meetings.

### Setting the Scene

The developer has multiple options for setting the scene.

In Automatic Mode, the developer leaves it up the service to automatically establish the scene. Once the room starts mapping and a suitable area is established then the scene can be set up automatically.

In the Director Control Mode, the developer can give the director the ability to setup the location and size of the scene. For example, the director opens the app and a 3D mesh box is created showing the size and area of the scene. The director can control the location and scale of the scene in question as long as it fits within the bounded region.

In Best Device Mode, if multiple people enter an initial scene before it is setup then the developer can have the service pick the device that provides the best mapped data of the area and gives that person control of the setting up the scene.

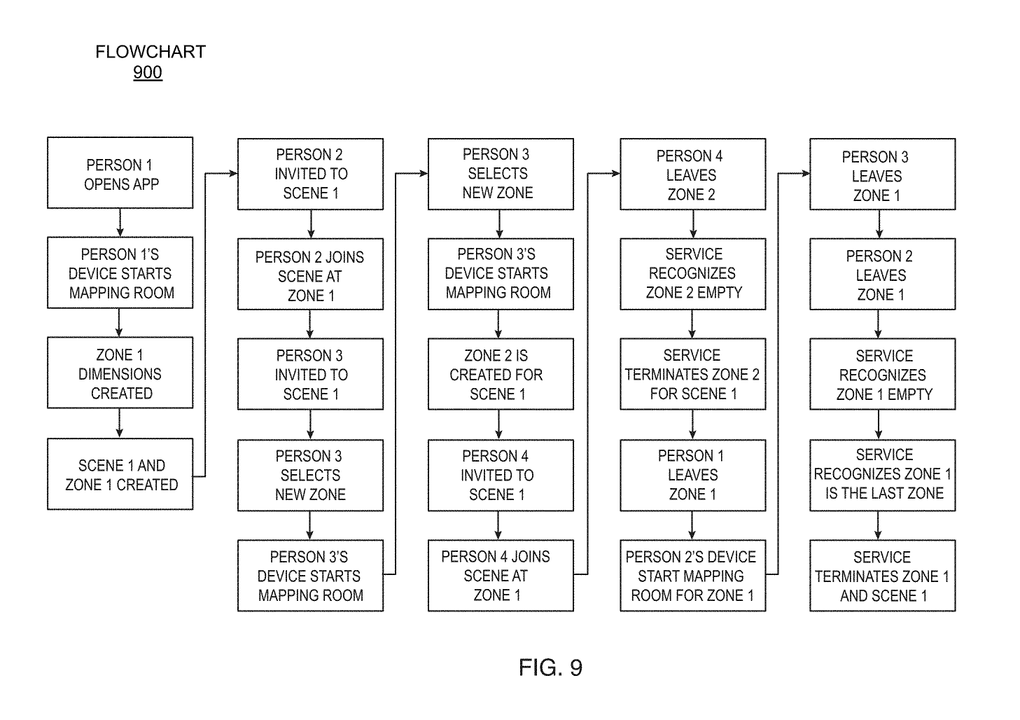

In Fallback Mode, the developer can give the director control, but if the director does not have a capable device for establishing a proper scene it can fallback to automatic mode and let the service pick the location, size, and scale of the scene. FIG. 9 depicts a flowchart 900 illustrating a flow for users joining a scene in accordance with embodiments of the present disclosure. In this instance the developer is automatically setting the scene based on mapping data provided by the device. Furthermore, the developer has the ability to configure extra constraints such as minimum and maximum sizes for scenes.

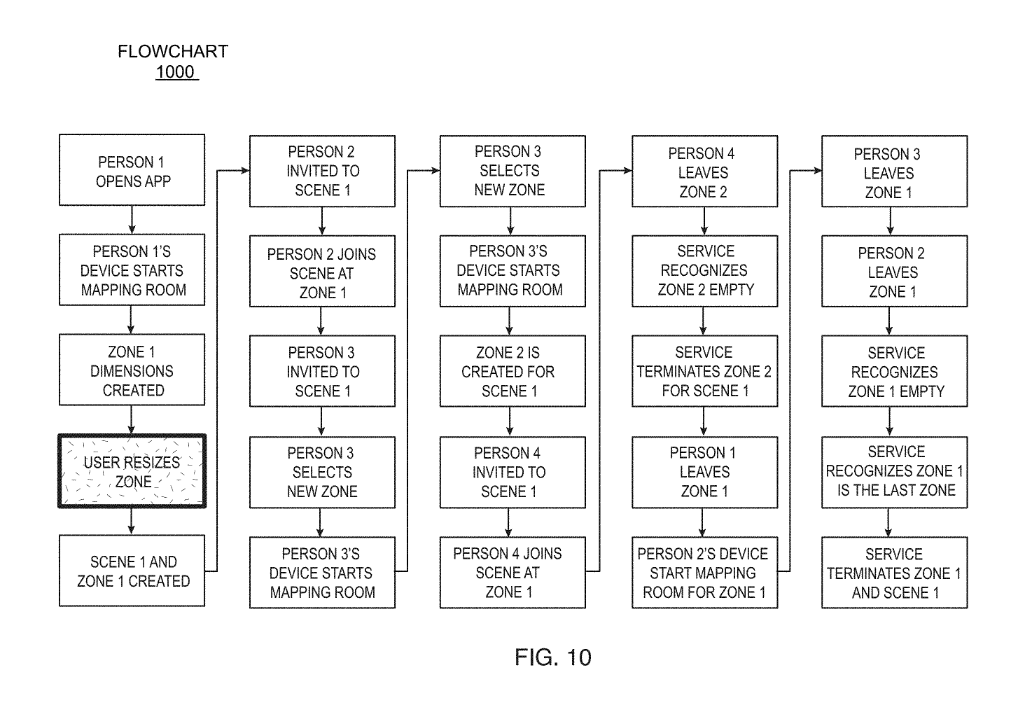

FIG. 10 depicts a flowchart 1000 illustrating another flow for users joining a scene in accordance with embodiments of the present disclosure. In this instance the developer has given control of establishing the scenes to the director and zone managers.

### Audio

Visually viewing scenes from different zones is not the only benefit. Communication is key when working from remote locations. That is why Scene Flow has the ability to easily set up communication between all of the different participants within the different zones.

This improves upon two different areas from both video/audio conferences and video games. Since there is the ability for multiple groups to join a scene and they are broken down into zones, Scene Flow can use that to provide more fine grained control over the audio experience.

With digital meetings people all join the same space and either use software or a phone to communicate in that particular meeting. People can mute on a one-by-one basis. With zones Scene Flow has a group level control that can be applied to inputting and outputting audio.

Scene Flow can improve video games by again having this zone. Right now, most games today require the user to wear a headset so each player can talk and listen. The audio might be isolated to a specific group depending on which team the user is on. This can be extended by having access to the audio input and output of various zones. Groups of people can be isolated on a zone basis or everyone has the ability to chat within a scene for more collaborative game play. Each zone has its own input and output channels. Typically a zone does not output audio from its own zone.

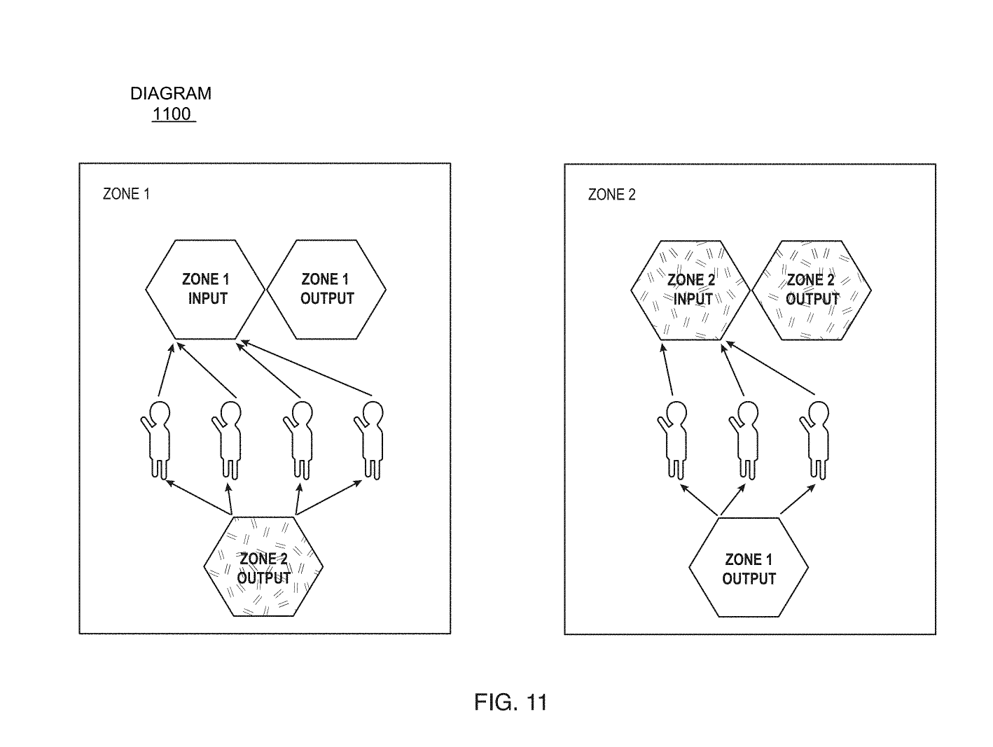

FIG. 11 depicts a diagram 1100 illustrating a simple setup for delivering audio to certain zones in accordance with embodiments of the present disclosure. In this instance there is no reason to output audio from the same zone that is receiving input.

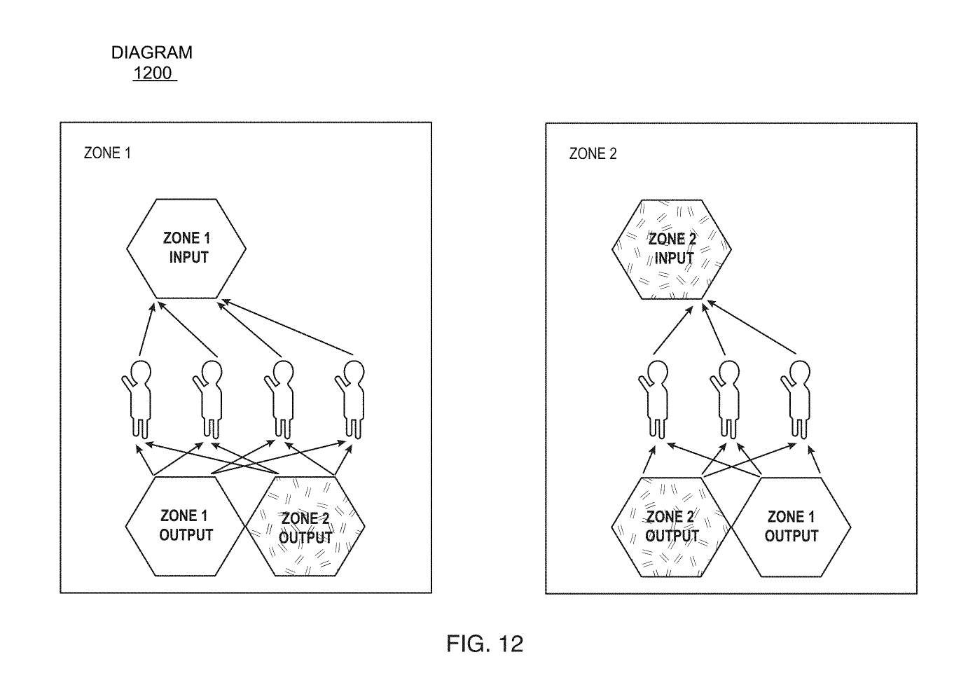

Depending on the scene that is occurring, it might be necessary to provide audio for people within the same zone as well. FIG. 12 depicts a diagram 1200 illustrating a simple setup for delivering audio to all zones in accordance with embodiments of the present disclosure. In this instance audio is loud enough from the scene itself that Scene Flow outputs audio from all the different zones even if people are standing near each other.

### Audio Responsibility

Since Scene Flow has the concept of different zones, Scene Flow also has the ability to isolate zones from each other for different experiences. This scenario is discussed in more detail in the battlefield game night use-case.

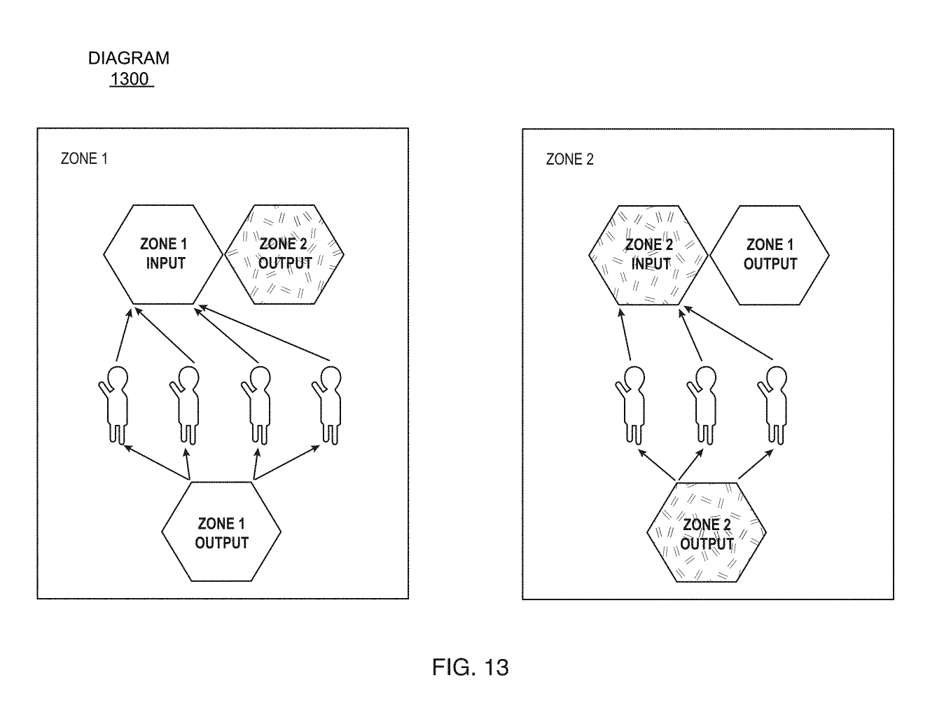

FIG. 13 depicts a diagram 1300 illustrating a developer isolating the audio from each zone for a battlefield game in accordance with embodiments of the present disclosure. All of the players are playing on the same scene, but are broken into teams. Since this is a game the developer would most likely offer the zone manager the ability to provide audio output from their own respective zone to all of the players standing there.

### Perspective

There are two levels Scene Flow can have for a user's perspective of the mixed-reality scene. If the user is viewing the scene from a device such as a phone or tablet, then Scene Flow can use the camera's field-of-view as what the user can see at any given time. However, devices will get more advanced and will be able to track where the user is looking. Scene flow can have the ability to show them a vector of the person's line of sight.

This is an improvement over teleconference meetings today since people are looking at certain areas of their screen. Users do not know if they are viewing the document being shared or checking their email. This gives better context as to what people are looking at during a given point in time.

Having each user's perspective extends beyond the realm of being able to tell what people are looking at. This gives greater control to developers as well. For instance, say that a user is using a standard game controller to interact with a scene. As they walk around the scene the controller's controls can be updated based on the user's position relative to the scene.

This is an improvement over current teleconference and gaming experiences today. Typically you are viewing and interacting with the content from a screen which gives you one perspective of the content. In games this is enhanced by having a virtual camera which you can control so you can see the world from different perspectives. The scenes and zones projected into the physical space in the real world take into account that people can now move around and through the content, their perspectives are no longer stationary. The platformer action game use-case expands on this example

Interacting with the Scene

A crucial aspect to mixed reality experiences is the ability to interact with the content. This is a key improvement over today's teleconference. It is typical that one person controls and drives the content being shared on the screen. In some instances they are able to hand control of their screen to another participant. This is especially useful for helpdesk support troubleshooting issues on a person's computer or mobile device.

However, with sharing content in 3D space it is necessary to allow multiple people to participate and interact with the content. Scene Flow makes it easy to do that. Interacting with a particular scene is dependent upon various factors such as the device a person is using, the admin privileges they have at the time, and whether objects are marked interactive.

### Devices

How users can interact with a scene and whether they can interact with a scene can often depend on the type of device that they are using. As mixed-reality devices get more advanced there are different ways to interact with the scenes. At some point they could simply use their hands and fingers to manipulate the scene. However, everyone may not have such a nice device, or they simply did not bring their mixed-reality headset over. But they may have a mixed reality capable phone on hand. They should still be able to view the scene and maybe have a limited ability to interact with the scene. For the first time, people on different platforms have the ability to share mixed-reality experiences as long as they have a mixed-reality capable device.

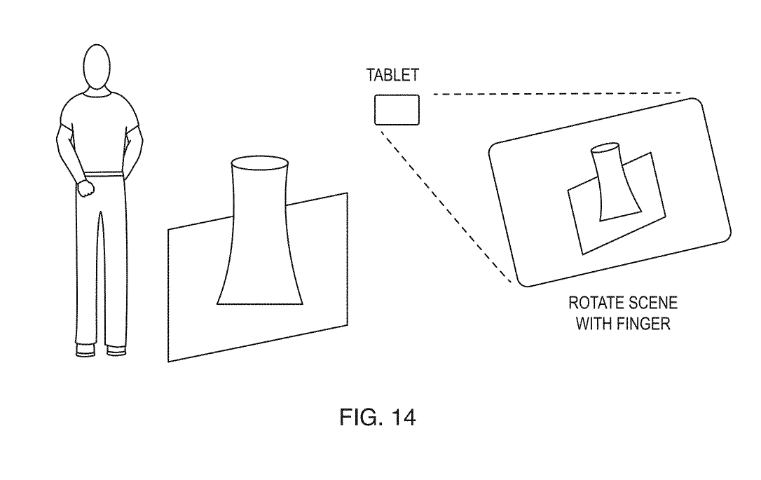

FIG. 14 depicts a diagram 1400 illustrating a simple scene where a person is using a tablet to view the scene in accordance with embodiments of the present disclosure. Note; the person is not drawn behind the tablet. They can use one finger to rotate the volcano and the scene rotates for everyone viewing the scene.

### Actors and Spectators

This is meant to provide the ability to bring people in-and-out of these spaces seamlessly, and give them specific control. Currently, during teleconference meetings people can share their screen or request to control another person's screen.

Scene Flow improves upon this idea since multiple people can interact with a scene at once. There is fine grained control on letting people interact with a scene or letting them act as a spectator. Scene Flow can extend this behavior to the zone level as well. Say for example there is a scene with three zones.

Perhaps only zone one can interact with the scene and zones two and three are only allowed to view the scene. The classroom use-case expands on this example.

### Interactive Objects

Developers have the ability to choose whether objects can be interacted with or not. This is standard across most Operating Systems and devices today. Developers have an extra level of control when dealing with interactions using the Scene Flow service. They can limit how an object is interacted with and how many points of data there needs to be for an item to be used. For instance, phones can only deliver two points (x, y) when delivering a touch. A developer can designate that a specific object needs at least three points (x, y, and z) for a touch to be delivered.

In addition, they are not limited to just the device type. The director has multiple levels of control when dealing with whether people can interact with the scene. They have the ability to lock down zones so no users can interact with them. They have the ability to leave zones open and determine it by device. They can give managers of the zones control on whether they allow people to interact with the scene.

### The Service

The service takes the technology described above and creates a managed service for developers that scales despite the number of people that join. There are numerous benefits to be gained by using the service such as auto scaling as more zones and users are added to a scene. The service also finds and delivers mapped data from devices. Mixed reality differs from online games with the need for mapping the surrounding physical area.

### APIs and Client SDKs

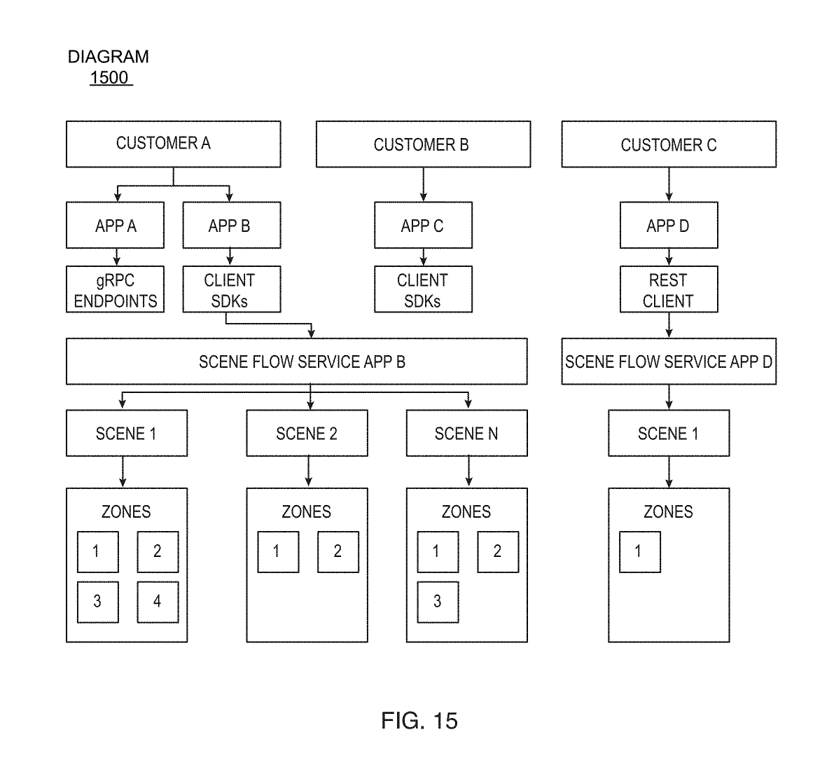

Since Scene Flow supports many different platforms, Scene Flow makes it easy for developers to create scenes, zones, and invite people to and from the scenes and zones. For the most popular platforms Scene Flow provides Client SDKs that developers can easily use. In addition, Scene Flow provides direct access through specific transport protocols depending on the developer's needs. This ensures they do not need to rely on Scene Flow's SDKs to perform any tasks associated with the service. FIG. 15 depicts a diagram 1500 illustrating Scene Flow managing multiple scenes and zones within those scenes for a customer in accordance with embodiments of the present disclosure.

FIG. 15 further illustrates different companies leveraging the Scene Flow service. Customer A has multiple apps registered and Customers B and C only have one app. Customer A's App B is implemented on multiple platforms such as iOS, Android, and other AR platforms using the applicable SDKs that Scene Flow provides. They use the SDKs to connect to the Scene Flow service. This gives them the ability to generate scenes and zones as users launch their app and use it. Again, using App B as an example, it has multiple scenes set up by different users and multiple zones within that scene.

The SDKs are not limited to just setting up scenes and zones. They are also used for helping to manage the various zones as well such as (1) manage the audio input/output for each zone; (2) manage bringing users in and out of zones; (3) send notifications for updating the status of people being registered as directors, managers, actors, and/or spectators; (4) send notifications for new zones being created, resized and removed; (5) report errors for zones that may have unexpectedly shut down; (6) mark UI Elements as interactive; (7) send user interactions to the service While the list above is not all inclusive it shows a lot of capabilities provided by the Client SDKs.

### Example Use-Cases

This section provides various use-cases for the Scene Flow service. The examples included here emphasize what becomes capable when the users are allowed to create different zones and allow people to interact with the scenes using different devices.

### Battlefield Game Night

Family and friends are playing a new mixed-reality board game tonight. The game is more engaging if users are able to walk around the board and see it from different perspectives. It is a battlefield game and multiple teams can play together. One family sets up the initial scene in their living room, and a few of the kids set up a separate zone on the dining room table. Their friends in another house want to play as well and set up a third zone in their living room which is across town. The family is short one headset but their daughter is using her phone to view the game and help provide information to her team even though she cannot actively participate.

Before the game begins everyone is able to communicate across all of the zones. Once the game begins the audio is isolated to each zone so the teams can discuss their strategy without letting the other team in on their secrets. Each team is able to view the game from their scene and see the entire battlefield. They are able to interact, place troops, and attack other teams. If two zones do not have enough players for each team, they can be combined into one group as a larger team. They would then share audio

### Engineering Meeting

There is an engineering meeting at a robotics company. They are designing a new bipedal robot that can rescue humans from burning buildings. A key component for this robot is to be able to run up and down stairs and avoid any pedestrians that might be in the way. The engineers are meeting to review the balance and posture of the robot using a simulated environment. The engineers setup a 3D space that has multiple sets of stairs and virtual pedestrians running down the stairs to escape the fire.

They are able to set up a scene in a giant conference room so they can get a detailed view of the virtual robot as it moves up and down the stairs. They are able to pause the simulation and can move forward and backward in time to see the robot's movement in more detail. They also want to make sure the robot is keeping a safe enough distance from pedestrians.

Several vice presidents who are visiting a client across the country are in a small conference room set aside for them. They have a smaller zone of the scene set up so they can watch the engineering review. The audio from the main zone is being broadcasted to them. In addition, they are seeing the pauses and playbacks of the simulation as the engineers are controlling it from the main zone. Since there is a lot going on in the scene the vice president of engineering is placing virtual markers at specific points of the scene giving the engineers better context to his questions.

The vice presidents have a meeting to attend with the client they are visiting. The director of the scene shuts down their zone, and the only zone remaining is the main zone that was initially set up.

### Classroom Lesson

The professor is standing in front of 200 plus students in one of the universities larger study halls. This lesson is about the Solar System and the different planets and asteroid belt. There is a giant scene set up above the class's heads as the solar system is projected into mixed reality. Everyone in the classroom is viewing the same scene.

The professor sets up a smaller zone on his desk using the Leap Motion controller a device that projects an infrared light field which it then reads data from. This creates a cone with about a 2.6 ft. reach from the devices surface. A smaller zone is automatically generated within this light field. This makes the larger scene at zone 1 controllable through zone 2 which exists within the infrared field produced by the Leap Motion controller.

Now, zone 1 is then marked as a spectator zone so no one can control and interact with the scene from that zone. This gives the professor the ability to control the larger scene above the classes head. He can tap on a planet to zoom in and the class is able to follow along on the larger scene. The professor can pinch to zoom back out to the larger solar system. This scenario can be adapted to any lesson whether it is biology, chemistry, geography, history, etc.

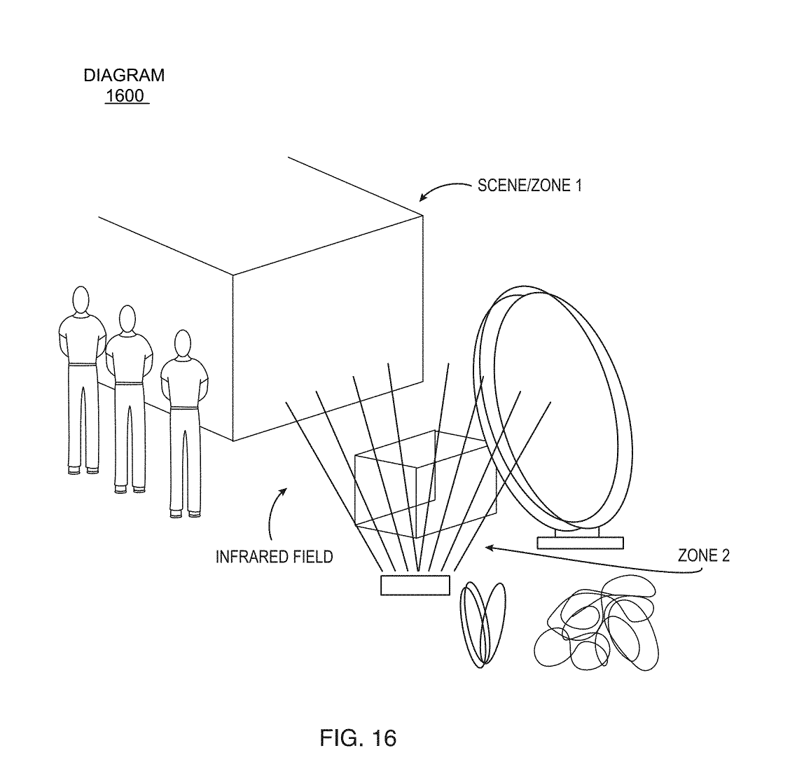

FIG. 16 depicts a diagram 1600 illustrating two zones setup for a scene in accordance with embodiments of the present disclosure. Zone 1 is the larger zone with a group of people looking at it. Someone is using zone 2 to control the entire scene. Zone 2's dimensions were generated based on the size of the infrafield from the device.

### Football Game

A crowd of people go to see their favorite teams on the football field. A visual effects team is able to setup a scene that is the size of the football field. The QR Code on a ticket stub gives the user access to the mixed reality scene if the user has a compatible device. This adds extra metadata to the field to help enhance the game.

The crowd sitting in the furthest seats can add some extra information to help see the players' numbers above their heads as they move on the field. The user has the ability to replay runs on the field as the players movements are superimposed on the field.

Another group of friends sitting at home watching the game can share a different experience. As players are introduced 3d projections of those football players can appear. Everyone in the room has the ability to flip through the various players or view the other team. They can setup multiple augmented screens so they can watch multiple games at once. The most important aspect is that the screens are all in the same location for each person in the room. They can point and talk about what was just seen and everyone understands because they are all viewing the same augmented space.

### The Great White Shark and Device Required

Three friends are working on a school project, they are studying the great white shark, and plan to set up a scene and three separate zones in each their houses for viewing the scene. This is a major new release for an aquatic anatomy app, and no longer supports touch support from mobile devices such as phones and tablets. Jessica starts the app from her phone and selects the “New Session” button. The app shows Jessica a warning, “At least one person with a 3D input device must be present to control and work with the scene”. Jessica invites Victor to the scene and he enters into zone 2 with the required device. Jessica no longer sees the warning and is able to talk about the shark and view the scene as Victor controls the great white shark with his controller. Zoe enters the scene as well from zone 3 and is also able to control the scene with Victor since she has a 3D input device. Once they are finished Victor and Zoe sign-off and zones 2 and 3 are shut down. Jessica once again sees the warning “At least one person with a 3D input device must be present to control and work with the scene”. However, she is still able to view the shark and walk around and view it even though she cannot make changes to it. She exits the app and the zone and scene are shut down.

### Platformer Action Game

Two players, Joe and Alex start playing a new action game. They are in the same location so they are both in the same zone that is holding the scene. They are each holding a Steam Controller that they are using to control their characters. As the game begins they find they need to circle around the zone to be able to see their character clearly and avoid obstacles in the game. This brings a new dynamic to the content since it is no longer viewed from a screen such as a television or a computer monitor.

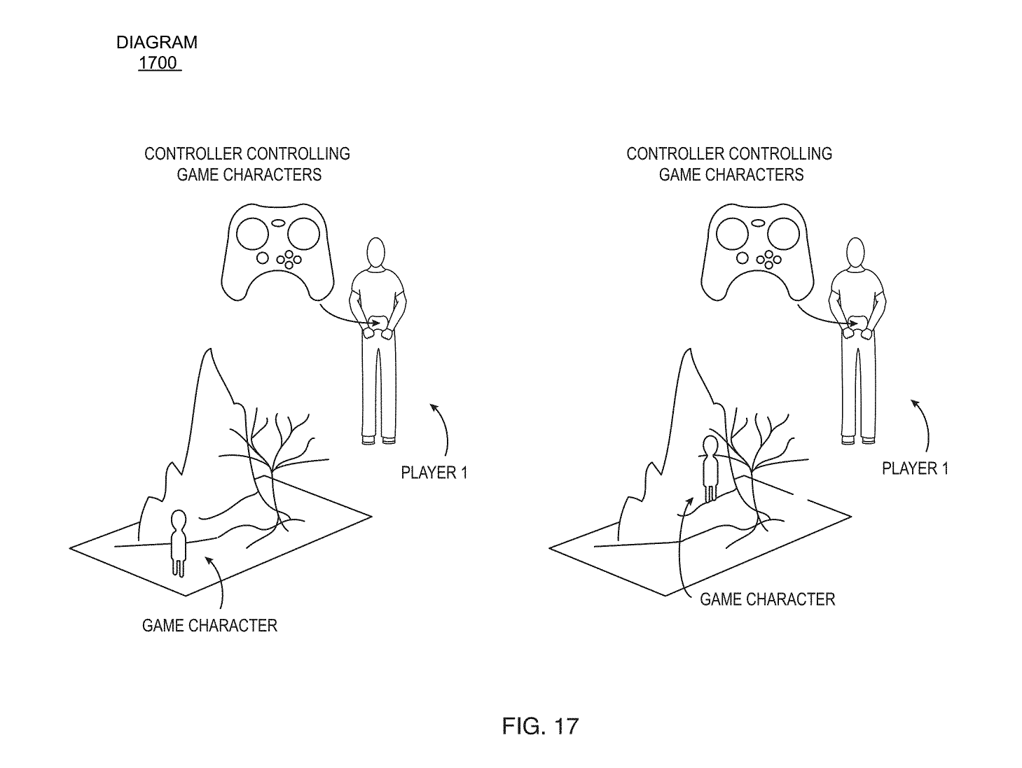

FIG. 17 depicts a diagram 1700 illustrating the platformer action game concept in accordance with embodiments of the present disclosure. Only one player is shown in the drawing. As they walk around the scene, the mapping on their steam controller updates so they can continue to control their character in a logical manner. For instance, if the player is moving the character to the right, and they move around the scene then the controls will still point logically to the right.

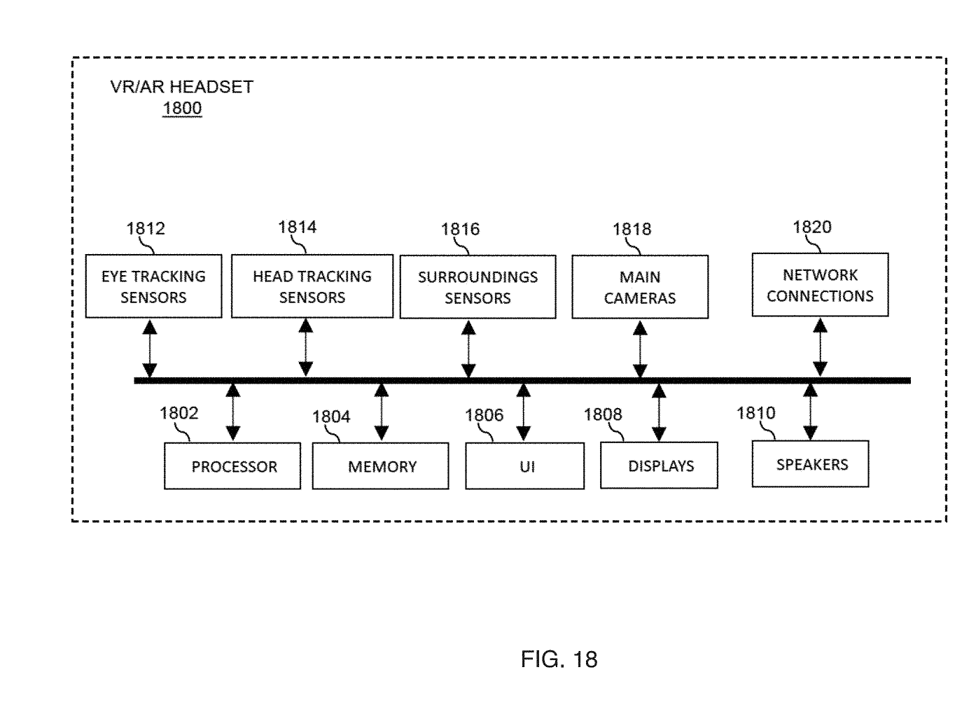

FIG. 18 depicts a block diagram illustrating a virtual reality/augmented reality (VR/AR) headset 1800 in accordance with embodiments of the present disclosure. The VR/AR headset 1800 may be a VR only headset, an AR only headset, or a headset including both VR and AR functionality. The VR/AR headset 1800 may include at least a processor 1802, a memory 1804, a UI 1806, a display 1808, and speakers 1810. The memory 1804 may be partially integrated with the processor 1802. The memory 1804 may include a combination of volatile memory (e.g. random access memory) and non-volatile memory (e.g. flash memory). The UI 1806 may include a touchpad display. The displays 1808 may include left and right displays for each eye of a user. The speakers 1810 may be positioned within the headset. In other embodiments, the speakers 1810 may be provided as earbuds or headphones. Connections to the speakers 1810 may be wired or wireless (e.g. Bluetooth®).

The VR/AR headset 1800 may also include eye tracking sensors 1812, head tracking sensors 1814, surroundings sensors 1816, main cameras 1818, and network connections 1820. The eye tracking sensors 1812 may include cameras co-positioned with the displays 1808. The head tracking sensors 1814 may include a three-axis gyroscope sensor, an accelerometer sensor, a proximity sensor, or the like. The surroundings sensors 1816 may include cameras positioned at a plurality of angles to view an outward circumference of the VR/AR headset 1800. The main cameras 1818 may include high resolutions cameras configured to provide main left eye and right eye views to the user.

The network connections 1820 may include WAN radios, LAN radios, personal area network (PAN), or the like. The WAN radios 1910 may include 2G, 3G, 4G, and/or 5G technologies. The LAN radios 1912 may include Wi-Fi technologies such as 802.11a, 802.11b/g/n, and/or 802.11ac circuitry. The PAN radios 1912 may include Bluetooth® technologies.

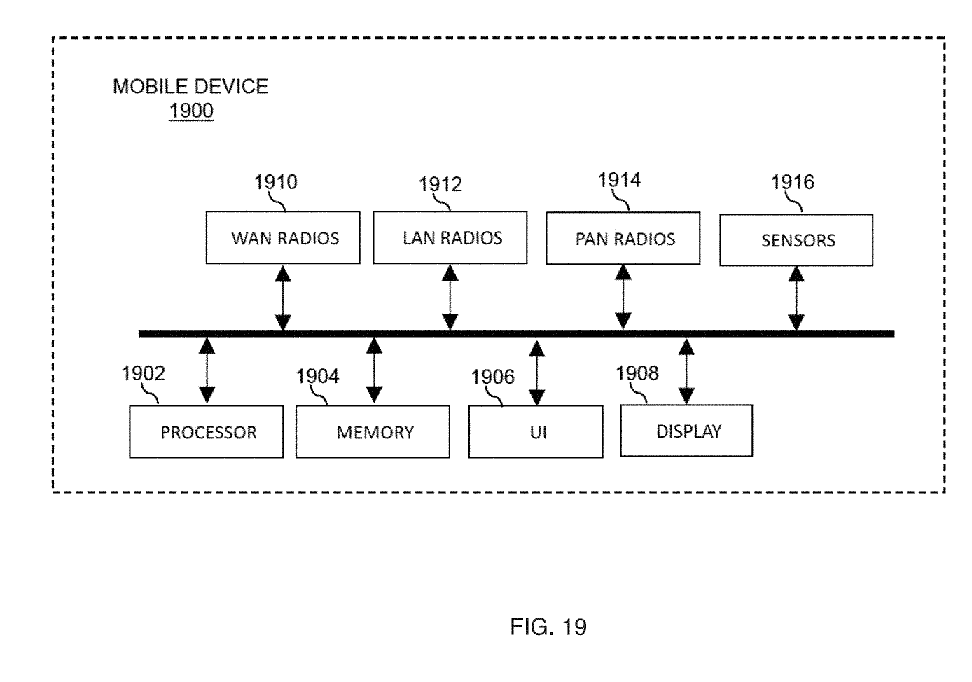

FIG. 19 depicts a block diagram illustrating a mobile device 1900 in accordance with embodiments of the present disclosure. The mobile device 1900 may be a laptop, a smart TV, a smartphone, a holographic projector, or the like. In some embodiments, the mobile device 1900 may host a web application or a mobile app specific to the disclosure. The mobile device 1900 may include at least a processor 1902, a memory 1904, a UI 1906, a display 1908, WAN radios 1910, LAN radios 1912, PAN radios 1914, and sensors 1916. Sensors 1916 may include a global positioning system (GPS) sensor, a magnetic sensor (e.g. compass), a three-axis gyroscope sensor, an accelerometer sensor, a proximity sensor, a barometric sensor, a temperature sensor, a humidity sensor, an ambient light sensor, or the like In some embodiments the smartphone 900 may be an iPhone® or an iPad®, using iOS® as an OS. In other embodiments the smartphone 900 may be a mobile terminal including Android® OS, BlackBerry® OS, Windows Phone® OS, or the like.

In some embodiments, the processor 1902 may be a mobile processor such as the Qualcomm® Snapdragon™ mobile processor. The memory 1904 may include a combination of volatile memory (e.g. random access memory) and non-volatile memory (e.g. flash memory). The memory 1904 may be partially integrated with the processor 1902. The UI 1906 and display 1908 may be integrated such as a touchpad display. The WAN radios 1910 may include 2G, 3G, 4G, and/or 5G technologies. The LAN radios 1912 may include Wi-Fi technologies such as 802.11a, 802.11b/g/n, and/or 802.11ac circuitry. The PAN radios 1912 may include Bluetooth® technologies.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium (including, but not limited to, non-transitory computer readable storage media). A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including object oriented and/or procedural programming languages. Programming languages may include, but are not limited to: Ruby, JavaScript, Java, Python, Ruby, PHP, C, C++, C#, Objective-C, Go, Scala, Swift, Kotlin, OCaml, or the like. The program code may execute entirely on the user's computer, partly on the user's computer, as a stand-alone software package, partly on the user's computer, and partly on a remote computer or entirely on the remote computer or server. In the latter situation scenario, the remote computer may be connected to the user's computer through any type of network, including a LAN connection, a WAN connection, or the like. The connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method implemented on at least one server for providing shared mixed reality experiences, the method comprising:
identifying interface requirements for a set of services to be implemented between service-oriented architecture (SOA) front-end components and SOA back-end components, wherein:
at least one of the SOA front-end components is configured for communicating with at least one augmented reality (AR) user interface;
at least one of the SOA back-end components is configured for communicating with at least one virtual object library; and
the SOA front-end components are operable to be combined with the SOA back-end components to form an operable SOA solution.

2. The method of claim 1, wherein at least one of the SOA front-end components is configured for communicating with at least one virtual reality (VR) user interface.

3. The method of claim 2, wherein the at least one VR user interface is provided by at least one of a VR headset, a personal computer (PC), a workstation, a laptop, a smart TV, a smartphone, and a holographic projector.

4. The method of claim 2, wherein at least at least one of the SOA back-end components is configured for communicating with at least one VR environment.

5. The method of claim 4, wherein the at least one VR environment is at least one of a massively multiplayer online game (MMOG), a collaborative VR environment, and a massively multiplayer online real-life game (MMORLG).

6. The method of claim 4, wherein at least one of the SOA front-end components is configured for communicating with at least one real world interface.

7. The method of claim 6, wherein the real world interface is provided by at least one of a video camera, a photo camera, and a microphone.

8. The method of claim 6, wherein the operable SOA solution is configured to generate at least one real world virtual object using information received from the real world interface.

9. The method of claim 8, wherein the operable SOA solution is further configured to provide the at least one real world virtual object to the at least one AR user interface.

10. The method of claim 8, wherein the operable SOA solution is further configured to provide the at least one real world virtual object to the at least one VR user interface.

11. The method of claim 8, wherein the operable SOA solution is further configured to provide the at least one real world virtual object to the at least one virtual object library for off-line storage.

12. The method of claim 8, wherein the operable SOA solution is further configured to provide the at least one real world virtual object to the at least one VR environment.

13. The method of claim 1, wherein the at least one AR user interface is provided by at least one of an AR headset, a personal computer (PC), a workstation, a laptop, a smart TV, a smartphone, and a holographic projector.

14. The method of claim 1, wherein the at least one virtual object library is the Google Poly VR and AR virtual library.

15. The method of claim 1, wherein at least one of the SOA front-end components is configured to communicate over the Internet.

16. The method of claim 1, wherein at least one of the SOA front-end components is configured to communicate over at least one of an hypertext transfer protocol (HTTP) session, an HTTP secure (HTTPS) session, a secure sockets layer (SSL) protocol session, a transport layer security (TLS) protocol session, a datagram transport layer security (DTLS) protocol session, a file transfer protocol (FTP) session, a user datagram protocol (UDP), a transmission control protocol (TCP), and a remote direct memory access (RDMA) transfer.

17. The method of claim 1, wherein at least one of the SOA back-end components is configured to communicate over the Internet.

18. The method of claim 1, wherein the at least one server is a portion of a networked computing environment.

19. A server for providing shared mixed reality experiences, the server comprising:
at least one memory; and
at least one processor configured for:
identifying interface requirements for a set of services to be implemented between service-oriented architecture (SOA) front-end components and SOA back-end components, wherein:
at least one of the SOA front-end components is configured for communicating with at least one augmented reality (AR) user interface;
at least one of the SOA back-end components is configured for communicating with at least one virtual object library; and
the SOA front-end components are operable to be combined with the SOA back-end components to form an operable SOA solution.

20. A non-transitory computer-readable storage medium for providing shared mixed reality experiences, the non-transitory computer-readable storage medium storing instructions to be implemented on at least one computing device including at least one processor, the instructions when executed by the at least one processor cause the at least one computing device to identify interface requirements for a set of services to be implemented between service-oriented architecture (SOA) front-end components and SOA back-end components; wherein:
at least one of the SOA front-end components is configured for communicating with at least one augmented reality (AR) user interface;
at least one of the SOA back-end components is configured for communicating with at least one virtual object library; and
the SOA front-end components are operable to be combined with the SOA back-end components to form an operable SOA solution.
